(19) United States
(12) Patent Application Publication
(10) Pub. No.: US 2003/0161469 A1
(43) Pub. Date: Aug. 28, 2003

(54) Method and apparatus for embedding data in compressed audio data stream

(76) Inventors: Szeming Cheng, College Station, TX (US); Hong Heather Yu, Princeton Jct., NJ (US); Zixiang Xiong, College Station, TX (US); Taro Katayama, Osaka (JP)

Correspondence Address: HARNESS, DICKEY & PIERCE, P.L.C., P.O. BOX 828, BLOOMFIELD HILLS, MI, 48303, US

(21) Appl. No.: 10/082,511

(22) Filed: Feb. 25, 2002

(51) Int. Cl. H04N 7/167

(52) U.S. Cl. 380/217

(57) ABSTRACT

The present invention embeds watermark into quantization indices of the compressed data stream rather than the coefficients, thereby avoiding loss of speed from dequantization or requantization. Further, a heuristic technique is preferably chosen for selecting the indices and respective modification amounts, thereby avoiding the need for comparison with the original signal. Specific to this technique, indices are chosen corresponding to ranges within a sensitive portion of a human sensory range, zero indices are discarded, and a minimum amount is always determined. Still further, the same codebook is used to partially compress and partially decompress the compressed data stream, thereby avoiding complexity associated with multiple searches for optimum codebooks.

### FIELD OF THE INVENTION

The present invention generally relates to data hiding, and in particular relates to data hiding techniques operating directly on compressed domain data streams.

### BACKGROUND OF THE INVENTION

There is considerable interest today in embedding data, such as digital watermarks, into compressed data streams, like compressed audio data streams. Known methods have generally embedded data into compressed media data stream by applying distortion to frequency coefficients, such as Discrete Cosine Transform (DCT) coefficients or Modified Discrete Cosine Transform (MDCT) coefficients. As a general rule, perceptual modeling has been applied to determine how much distortion can be withstood by each coefficient to ensure perceptual quality of the host media data stream.

Many works have been done on compressed image and video data streams. Methods for embedding data into MPEG I Layer 3, MP3, formatted compressed audio data stream have also been proposed. A method for embedding data into MPEG II AAC bit stream taught in C. Neubauer and J. Herre, “Audio Watermarking of MPEG-2 AAC Bit Streams,” herein incorporated by reference, has partially decoded the compressed audio data stream to the frequency domain and requantized it after embedding a perceptually imperceivable watermark. The magnitude of the watermark embedded into each frequency coefficient has been determined by the perceptual weighting, which has been assumed to be recorded during original compression and passed along with the compressed audio.

One drawback of the aforementioned method is the computation complexity in dequantization and requantization. For some applications, such as online watermark embedding, faster watermark embedding/decoding speed and reduction in structural complexity is desirable. Providing such a solution is one task of the present invention. Another drawback of the aforementioned methods is that, in many applications, the perceptual modeling information is not available when watermark is added. The perceptual modeling information is not available, for instance, when an online third party merchant is selling music that was originally stored in AAC compressed format by a studio. It is unlikely and unreasonable for the compressed audio clip to store this extra information. Although it is possible to approximate the perceptual information from the compressed audio, consequences of approximation include increased complexity and inaccurate approximation of the perceptual model. Therefore, the need remains for a solution to the aforementioned problem. Providing such a solution remains another task of the present invention.

### SUMMARY OF THE INVENTION

According to various aspects, the present invention embeds watermark into quantization indices of the compressed data stream rather than the coefficients, thereby avoiding loss of speed from dequantization or requantization. Further, a heuristic technique is preferably chosen for selecting the indices and respective modification amounts, thereby avoiding the need for comparison with the original signal. This technique is especially useful for applications that do not need maximum data hiding capacity. Although this technique may not easily provide the maximum data hiding capacity in some cases, it is known that in many applications it is only necessary to hide several bits for its intended purpose. By providing a lower bound of possible modifications to minimize distortions while avoiding the need to use the original perceptual model used for compression, perceptual quality with low complexity is guaranteed while a wider range of applications may be employed. Specific to this technique, indices are chosen corresponding to ranges within a sensitive portion of a human sensory range, zero indices are discarded, and a minimum amount is always determined. Still further, the same codebook is used to partially compress and partially decompress the compressed data stream, thereby avoiding complexity associated with multiple searches for optimum codebooks.

In one aspect, the present invention is an encoding apparatus for embedding data in a compressed data stream. The apparatus comprises a partial decoder receptive of the compressed data stream and operable to partially decode the compressed data stream, thereby obtaining a partially decoded audio data stream having quantization indices. The apparatus further comprises an index selector in communication with said partial decoder, said index selector operable to select a plurality of the quantization indices using a heuristic technique, thereby obtaining selected indices, and to determine respective amounts by which to modify the selected indices. The apparatus further comprises a data embedder in communication with said partial decoder and receptive of the data and the partially decoded data stream, said data embedder operable to embed the data by modifying the selected indices according to the respective amounts, thereby obtaining a data-embedded partially decoded data stream. The apparatus further comprises a partial encoder in communication with said data embedder, said partial encoder operable to partially encode the data-embedded partially decoded data stream, thereby obtaining a data-embedded compressed data stream.

In another aspect, the present invention is a decoding apparatus for extracting data embedded in a compressed data stream having embedded data. The apparatus comprises a partial decoder receptive of the compressed data stream and operable to partially decode the compressed data stream, thereby obtaining a partially decoded data stream having quantization indices. The apparatus further comprises a correlation detector in communication with said partial decoder and operable to extract the data from the quantization indices.

In another aspect, the present invention is a method for embedding data in a compressed data stream. The method comprises receiving the data, receiving the compressed data stream, and partially decoding the compressed data stream, thereby obtaining a partially decoded data stream having quantization indices. The method further comprises selecting a plurality of the quantization indices, thereby obtaining selected indices, determining respective amounts by which to modify the selected indices, and embedding the data by modifying the selected indices according to the respective amounts, thereby obtaining a data-embedded partially decoded data stream. The method further comprises partially encoding the data-embedded partially decoded data stream, thereby obtaining a data-embedded compressed data stream.

In another aspect, the present invention is a method for extracting data embedded in a compressed data stream having embedded data. The method comprises receiving the compressed data stream, partially decoding the compressed data stream, thereby obtaining a partially decoded data stream having quantization indices, and extracting the data from the quantization indices, thereby obtaining data.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of an encoding apparatus according to the present invention;

FIG. 2 is a method for embedding data in a compressed data stream according to the present invention;

FIG. 3 is a decoding apparatus according to the present invention; and

FIG. 4 is a method for extracting embedded data according to the present invention.

### DETAILED DESCRIPTION OF THE PREFERRED EMBODIMENTS

The following description of the preferred embodiment(s) is merely exemplary in nature and is in no way intended to limit the invention, its application, or uses. In particular, the present invention is hereafter described with regard to a preferred implementation of compressed audio encoding and decoding using digital watermark with an enhanced spread spectrum technique. One skilled in the art will readily recognize that the present invention may be applied with diverse content of compressed bit streams and combined with various techniques to embed assorted types of data.

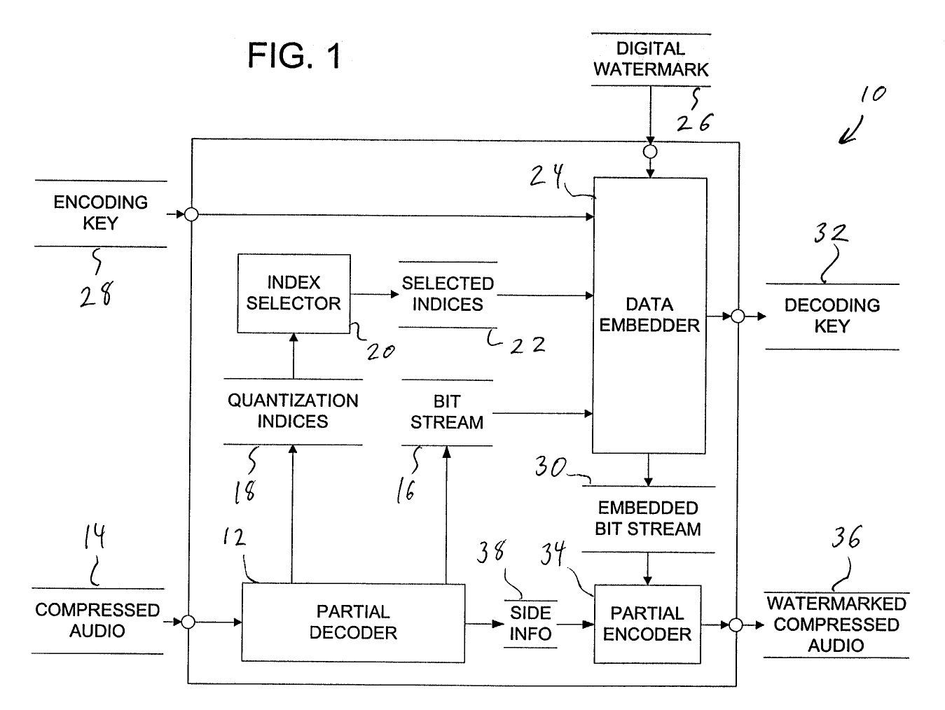

FIG. 1 illustrates an encoding apparatus 10 according to the present invention that preferably uses enhanced spread spectrum watermarking of digitized media by reducing the variance of the host signal prior to adding the watermark. The encoding apparatus 10, features a partial decoder 12 that is receptive of a compressed audio data stream 14, and operable to partially decode the compressed audio data stream, thereby obtaining a partially decoded audio data stream 16 having quantization indices 18. The apparatus further features an index selector 20 in communication with the partial decoder 12 that is operable to select a plurality of the quantization indices 18, thereby obtaining selected indices 22. Index selector 20 is further operable to determine respective amounts by which to modify the selected indices 22.

Ideally, index selection and respective modification amount determination can be accomplished by applying perceptual modeling to the original audio. For example, if one coefficient can tolerate a distortion of ten units and its current quantization step size is two units, then the corresponding index can be approximately varied by five steps without affecting the quality. However, as mentioned previously, this information is not easily accessible during watermark embedding in many applications. Therefore, a heuristic selection is preferred.

In accordance with heuristic selection, index selector 20 is operable to choose indices corresponding to ranges within a sensitive portion of a human sensory range. In the case of an audio data stream, frequency ranges to which human ears are more sensitive are preferably chosen. Index selector 20, is further operable to discard zero indices. In the case of audio, discarding zero indices avoids having distortion during silent periods. Further, index selector 20 is operable to always determine a minimum amount. In a preferred embodiment, this determination corresponds to always setting Δₙ to be 1, where Δₙ corresponds to a scalar multiplier for increasing an amount of noise detectable to an extraction system, and 1 is a substantially minimum setting.

Further in accordance with the present invention, the encoding apparatus 10 further comprises a data embedder 24 in communication with the partial decoder 12 and the index selector 20, and receptive of a digital watermark 26, an encoding key 28, the partially decoded data stream 16, and the selected indices 22. Data embedder 24 is operable to embed the data, in this case the digital watermark 26, by modifying the selected indices 22 based on the encoding key 28 and according to the respective amounts, thereby obtaining a data-embedded partially decoded data stream 30.

In accordance with the preferred embodiment, data embedder 24 is operable to enhance the selected indices 22 prior to adding the watermark. To do so, the selected indices 22 are sorted in either of an ascending or descending order. Then, a difference is computed for each pair of consecutive quantization indices, and the sign is alternated for every other difference value. Thus, an enhanced sequence of quantization indices is formed. Further implementation details for the enhanced spread spectrum watermarking technique are discussed in U.S. patent application “Enhanced Method For Digital Data Hiding” filed on Feb. 25, 2002 by the assignee of the present invention, which is herein incorporated by reference. It is envisioned that enhancement of the indices may alternatively be performed by the index selector 20, and that other components may be employed to accomplish the enhancement.

The data embedder 24 is further operable to generate a decoding key 32 based on whatever embedding technique is used. It is further envisioned that the selected indices 22 and the decoding key can be combined into a single signal dependent decoding key 32. An example of embedding follows with the preferred enhanced spread spectrum technique.

In accordance with the enhanced spread spectrum technique, a sorting step is defined as follows:

Let I_n be the selected index with n=1, . . . N from M indices (M>N);

Let S_n, n=1 . . . N be the sorting index;

i.e. x_{I_{S_{—}1}}≦x_{I_{S_{—}2}}≦x_{I_{S_{—}3}} . . . ;

Let J_n=I_{S_n}, (Note that 1≦J_n≦M, but there are only N number of J_n) hence x_{J_{—}1}≦x_{J_{—}2}≦x_{J_{—}3} . . . ;

Further, make the signal dependent, encoding/decoding key k′ as follows:

k′(J_n)=(−1)ⁿk([n/2]) for n=1 . . . N, where k is a user-supplied encoding key;

k′(p)=0 for any p not in {J_n|n=1 . . . N}.

In this case, the embedding step should simply be:

x′(n)=x(n)+w·k′(n), where w refers to a digital watermark bit.

Data embedder 24 thus produces the embedded bit stream 30 according to the above step(s). Further, data embedder 24 generates a signal dependent encoding/decoding key according to the above step(s). It is envisioned that similar embedding schemes may be derived for other circumstances that otherwise accomplish embedding of the data into the selected indices 22.

Encoding apparatus 10 also features a partial encoder 34 in communication with the data embedder 24 and receptive of the data-embedded partially decoded data stream 30. The partial encoder 34 is operable to partially encode the data-embedded partially decoded data stream 30, thereby obtaining a data-embedded compressed data stream 36. Preferably, the modified quantization indices after watermarking are compressed with Huffman coding using the original codebooks. While it is possible to search for the optimal set of codebooks again as in AAC encoding, this approach is not preferred for complexity considerations. Thus, to this and other ends, side information 38 is communicated from partial decoder 12 to partial encoder 34, wherein the side information 38 may include information relating to the original codebook, the original host signal, and/or the decoding process. Notably, encoding apparatus 10 exemplifies a method for embedding data in a compressed data stream according to the present invention.

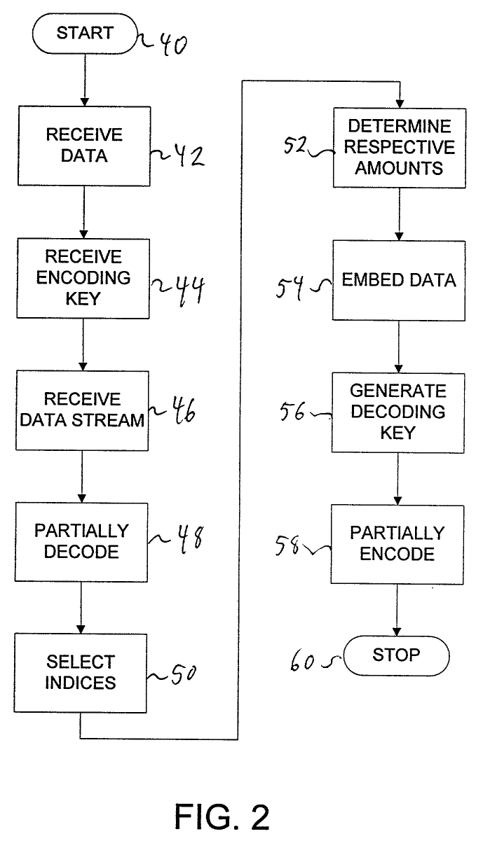

Referring to FIG. 2, a method for embedding data in a compressed data stream begins at 40 and proceeds to steps 42, 44, and 46, wherein data, such as digital watermark, an encoding key, and the compressed data stream are respectively received. The compressed data stream is partially decoded at step 48 to obtain a partially decoded data stream having quantization indices and indices are selected at step 50. Respective amounts for modifying the selected indices are also determined at step 52. At step 54, the data received in step 42 is embedded into the indices selected at step 50 according to the respective amounts determined at step 52, and based on the encoding key received at step 44. A decoding key is preferably generated at step 56 based on the encoding key received at step 44 and the embedding process of step 54. The partially decoded data stream with data embedded in quantization indices is partially encoded at step 58, and the method ends at 60.

Various preferred implementations of the steps described above exist. For example, same Huffman codebooks are used at steps 48 and 58. Further, steps 50 and 52 preferably employ a heuristic technique as described above. Still further, step 54 preferably employs enhanced spread spectrum watermarking disclosed above. Thus, step 54 is preferably based on the encoding key received at step 44 in that it embeds data based on the decoding key that was derived from the encoding key at step 56. Thus, order and implementation of steps may vary. It is also envisioned that more or less steps may be employed in various orders and/or combination to accomplish the present invention, and that other techniques will prove useful to that end. Step 42 and 44, for example, may occur in parallel, and may further occur in parallel with a series of steps 46, 48, 50 and 52. These steps may also be switched in order. Similarly, decoding according to the present invention may vary to accommodate variations in the encoding process.

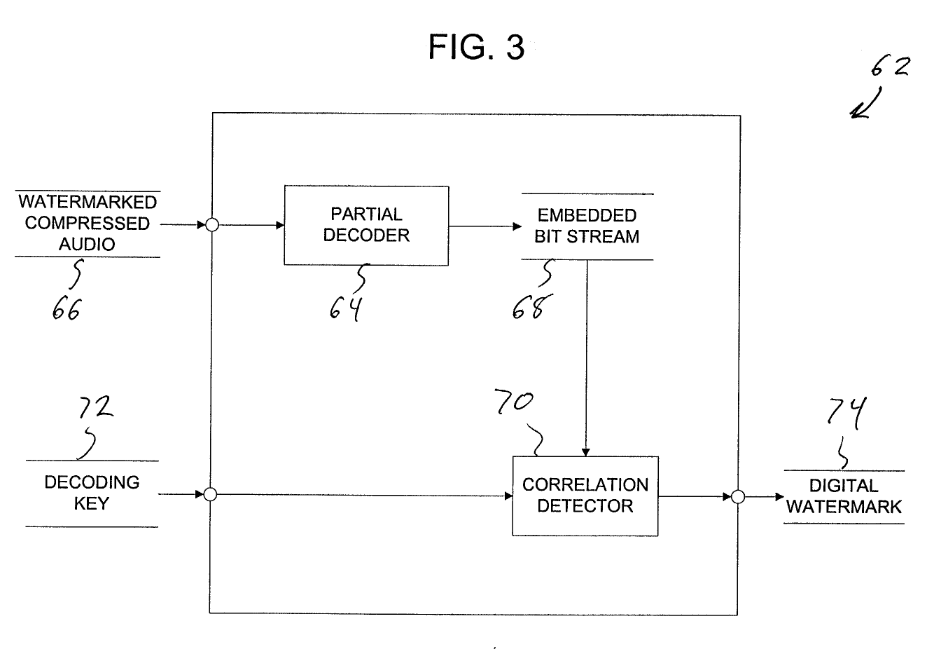

Referring to FIG. 3, a decoding apparatus 62 according to the present invention has a partial decoder 64 receptive of a compressed data stream 66 having data embedded in quantization indices according to the present invention. This partial decoder 64 is operable to partially decode the compressed data stream 66 to obtain a data-embedded partially decompressed data stream 68 having data-embedded quantization indices. Decoding apparatus 62 also has a correlation detector 70 receptive of a decoding key 72 and the data-embedded partially decompressed data stream 68. This correlation detector 70 is operable to extract the data from the data-embedded quantization indices, thereby obtaining the original data 74 that was embedded in the compressed data stream 66. An enhanced spread spectrum decoding technique is preferably used as a complement to the enhanced spread spectrum encoding technique, and the watermark extraction proceeds according to the following: w′=1 if Σₙx′(n)k′(n)>E[Σₙx(n)k(n)] and w′=0 otherwise, where w′ refers to the extracted watermark and E denotes an expected value.

During decoding, it is understood that the sorting indices and the watermark key are required. Instead of transferring them separately, it is envisioned that the sorting indices and the watermark key can be combined into a single signal dependent decoding key 72 which is in turn transmitted to the decoding apparatus 62. Notably, decoding apparatus 62 exemplifies a data extraction method according to the present invention.

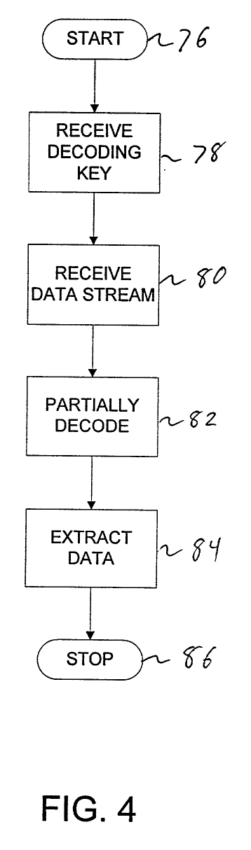

Referring to FIG. 4, the data extraction method according to the present invention begins at 76 and proceeds to steps 78 and 80, wherein a decoding key and the data-embedded compressed data stream are respectively received. The decoding key preferably includes information relating to the embedded indices. The data-embedded compressed data stream is partially decoded at step 82, and the data is extracted from the embedded indices at step 80 as more fully described above. The method ends at 84. It is also envisioned that more or less steps may be employed in various orders and/or combination to accomplish the present invention, and that other techniques will prove useful to that end. Step 78, for example, may occur in parallel with a series of steps 80 and 82. These steps may also be switched in order.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An encoding apparatus for embedding data in a compressed data stream, the apparatus comprising:
a partial decoder receptive of the compressed data stream and operable to partially decode the compressed data stream, thereby obtaining a partially decoded data stream having quantization indices;
a data embedder in communication with said partial decoder and receptive of the data and the partially decoded data stream, said data embedder operable to embed the data into the quantization indices, thereby obtaining a data-embedded partially decoded data stream; and
a partial encoder in communication with said data embedder, said partial encoder operable to partially encode the data-embedded partially decoded data stream, thereby obtaining a data-embedded compressed data stream.

2. The apparatus of claim 1 further comprising an index selector in communication with said partial decoder, said index selector operable to select a plurality of the quantization indices, thereby obtaining selected indices, and to determine respective amounts by which to modify the selected indices,
wherein said data embedder is operable to embed the data into the quantization indices by modifying the selected indices according to the respective amounts, thereby obtaining a data-embedded partially decoded data stream.

3. The apparatus of claim 2, wherein said index selector is operable to:
choose indices corresponding to ranges within a sensitive portion of a human sensory range;
discard zero indices; and
always determine a minimum amount.

4. The apparatus of claim 1, wherein said data embedder is receptive of an encoding key and operable to embed the data based on the encoding key.

5. The apparatus of claim 1, wherein the partially decoded data stream has variance, and wherein said data embedder is operable to reduce the variance of the partially decoded data stream.

6. The apparatus of claim 5, wherein said data embedder is operable to:
sort the partially decoded data stream in at least one of ascending and descending order, thereby obtaining a sorted sequence;
construct a new partially decoded data stream by taking the difference of every pair of two consecutive samples in the sorted sequence while alternating the sign of every other difference value; and
substitute the new partially decoded audio data stream for the partially decoded audio data stream.

7. The apparatus of claim 1, wherein said partial encoder and said partial decoder are operate via same codebooks.

8. A decoding apparatus for extracting data embedded in a compressed data stream having embedded data, the apparatus comprising:
a partial decoder receptive of the compressed data stream and operable to partially decode the compressed data stream, thereby obtaining a partially decoded data stream having quantization indices; and
a correlation detector in communication with said partial decoder and operable to extract the data from the quantization indices.

9. The apparatus of claim 8, wherein said correlation detector is receptive of a decoding key, and wherein said correlation detector is operable to extract the data from the quantization indices based on the decoding key.

10. A method for embedding data in a compressed data stream, the method comprising:
receiving the data;
receiving the compressed data stream;
partially decoding the compressed data stream, thereby obtaining a partially decoded audio data stream having quantization indices;
embedding the data into the quantization indices, thereby obtaining a data-embedded partially decoded data stream; and
partially encoding the data-embedded partially decoded data stream, thereby obtaining a data-embedded compressed data stream.

11. The method of claim 10 further comprising:
selecting a plurality of the quantization indices, thereby obtaining selected indices; and
determining respective amounts by which to modify the selected indices,
wherein said embedding the data into the quantization indices corresponds to modifying the selected indices according to the respective amounts.

12. The method of claim 11, wherein said selecting comprises:
choosing indices corresponding to ranges within a sensitive portion of a human sensory range; and
discarding zero indices.

13. The method of claim 11, wherein said determining corresponds to always determining a minimum amount.

14. The method of claim 10 further comprising receiving an encoding key, wherein said embedding the data includes modifying the selected indices based on the encoding key.

15. The method of claim 10, wherein the partially decoded data stream has variance, the method further comprising reducing the variance of the partially decoded data stream.

16. The method of claim 15, wherein said reducing comprises:
sorting the partially decoded data stream in at least one of ascending and descending order, thereby obtaining a sorted sequence;
constructing a new partially decoded data stream by taking the difference of every pair of two consecutive samples in the sorted sequence while alternating the sign of every other difference value; and
substituting the new partially decoded data stream for the partially decoded data stream.

17. The method of claim 10, wherein said partially encoding and said partially decoding are performed via same codebooks.

18. A method for extracting data embedded in a compressed data stream having embedded data, the method comprising:
receiving the compressed data stream;
partially decoding the compressed data stream, thereby obtaining a partially decoded data stream having quantization indices; and
extracting the embedded data from the quantization indices, thereby obtaining data.

19. The method of claim 18 further comprising receiving a decoding key, wherein said extracting is based on the decoding key.
